(19) United States
(12) Patent Application Publication
(10) Pub. No.: US 2022/0413755 A1
(43) Pub. Date: Dec. 29, 2022

(54) Handling Urgent Commands in a Data Storage Device

(71) Applicant: Western Digital Technologies, Inc., San Jose, CA (US)

(72) Inventors: Ramanathan Muthiah, Bangalore (IN); Laxmi Bhoopali, Bangalore (IN)

(21) Appl. No.: 17/356,031

(22) Filed: Jun. 23, 2021

(51) Int. Cl. G06F 3/06

(52) U.S. Cl. CPC G06F 3/0659; G06F 3/0611; G06F 3/0604; G06F 3/0679

(57) ABSTRACT

A data storage device including a non-volatile memory coupled to a controller. The controller is configured to transmit data between the non-volatile memory and an external electronic device and receive one or more commands to read or write data to the non-volatile memory. The controller is further configured to identify an urgent command in the one or more commands, transmit the urgent command to a negative index of an input queue of the data storage device, and execute a plurality of commands in the input queue.

### FIELD

This application relates generally to data storage devices, and more particularly, to a controller that manages queuing and execution of urgent commands transmitted to a data storage device during host read and/or write operations.

### BACKGROUND

A data storage device may receive one or more commands from an external electronic device (e.g., a host device). The one or more commands may enable reading and writing to a memory of the data storage device. However, in some situations, the external electronic device issues an urgent command to quickly read or write data to the memory of the data storage device. Typically, commands may be prioritized for execution by a controller of the data storage device based on a categorization of the type of request. However, assigning priority based on categorization does not allow specific commands within the same category to be prioritized. Further, assigning priority based on categorization does not allow a specific set commands of different categories to be prioritized.

For example, a flash translation layer (“FTL”) may maintain logical-physical address mapping and other data of the data storage device. Priority of commands may be assigned to host writes based on data streams, such as sequential and random. However, prioritization based on data stream does not allow urgent commands to be executed until the last leg of the storage backend. Thus, the current load in the backend affects the rate at which an urgent command may be executed.

In another example, a physical storage (“PS”) may process commands mapped to individual NAND dies of the data storage device. Priority of commands may be assigned based on a type of read and write, such as host read/write, relocation read/write, and control read/write. However, this prioritization does not allow a specific command within the type of read and write to be prioritized.

### SUMMARY

Generally, urgent commands issued to a data storage device are prioritized based categorization, thus the data storage device is unable to assign priority to specific commands issued to the device. Introducing a negative index to the input queue of the data storage device allows specific commands to be prioritized and executed by the data storage device without aborting previously issued commands.

One embodiment of the present disclosure includes a data storage device including a non-volatile memory and a controller coupled to the non-volatile memory. The controller is configured to receive one or more commands to read or write data to the non-volatile memory from the external electronic device. The controller is further configured to identify an urgent command in the one or more commands, transmit the urgent command to a negative index of an input queue of the data storage device, and execute a plurality of commands in the input queue.

Another embodiment of the present disclosure includes a method performed by a data storage device including a controller coupled to a non-volatile memory. The method includes receiving one or more commands from the external electronic device to read or write data to the non-volatile memory. The method further includes identifying an urgent command in the one or more commands, transmitting the urgent command to a negative index of an input queue of the data storage device, and executing a plurality of commands in the input queue.

Yet another embodiment of the present disclosure includes an apparatus including means for receiving one or more commands from the external electronic device to read or write data to the non-volatile memory. The apparatus further includes means for identifying the urgent command in the one or more commands, means for transmitting the urgent command to a negative index of an input queue of a data storage device, and means for executing a plurality of commands in the input queue.

Various aspects of the present disclosure provide for improvements in data storage devices. For example, optimizing the processes in which urgent commands are handled by data storage devices. The present disclosure can be embodied in various forms, including hardware or circuits controlled by software, firmware, or a combination thereof. The foregoing summary is intended solely to give a general idea of various aspects of the present disclosure and does not limit the scope of the present disclosure in any way.

### BRIEF DESCRIPTION OF THE DRAWINGS

FIG. 1 is block diagram of one example of a system for handling urgent commands for a data storage device, according to some embodiments.

FIG. 2 is block diagram illustrating one example of a data flow of the system for handling urgent commands for a data storage device of FIG. 1, according to some embodiments.

FIG. 3 is an illustrative example of a command execution queue, according to some embodiments.

FIG. 4 is a flow chart illustrating a method for handling urgent commands for a data storage device, according to some embodiments.

### DETAILED DESCRIPTION

In the following description, numerous details are set forth, such as data storage device configurations, controller operations, and the like, in order to provide an understanding of one or more aspects of the present disclosure. It will be readily apparent to one skilled in the art that these specific details are merely exemplary and not intended to limit the scope of this application. In particular, the functions associated with the controller can be performed by hardware (for example, analog or digital circuits), a combination of hardware and software (for example, program code or firmware stored in a non-transitory computer-readable medium that is executed by a processor or control circuitry), or any other suitable means. The following description is intended solely to give a general idea of various aspects of the present disclosure and does not limit the scope of the disclosure in any way. Furthermore, it will be apparent to those of skill in the art that, although the present disclosure refers to NAND flash, the concepts discussed herein are applicable to other types of solid-state memory, such as NOR, PCM (“Phase Change Memory”), ReRAM, etc.

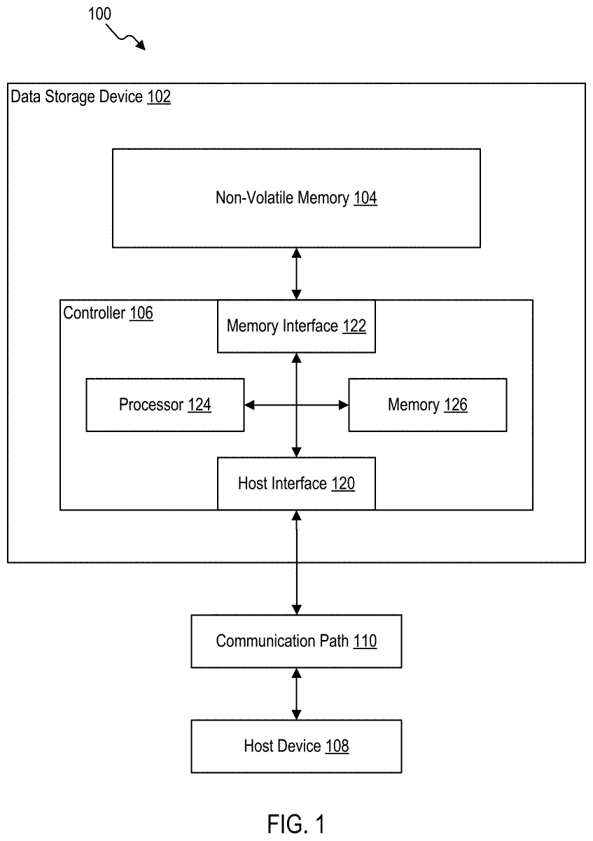

FIG. 1 is a block diagram of one example of a system 100 for handling urgent commands for a data storage device, in accordance with some embodiments of the disclosure. In some implementations, the data storage device 102 is a flash memory device. For example, the data storage device 102 is a solid state drive (“SSD”), Secure Digital SD® card, a microSD® card, or another similar type of data storage device. The data storage device 102 illustrated in FIG. 1 includes a non-volatile memory 104 and a controller 106. The data storage device 102 is coupled to a host device 108.

The data storage device 102 and the host device 108 may be operationally coupled via a connection (e.g., a communication path 110), such as a bus or a wireless connection. In some examples, the data storage device 102 may be embedded within the host device 108. Alternatively, in other examples, the data storage device 102 may be removable from the host device 108 (i.e., “removably” coupled to the host device 108). As an example, the data storage device 102 may be removably coupled to the host device 108 in accordance with a removable universal serial bus (USB) configuration. In some implementations, the data storage device 102 may include or correspond to an SSD, which may be used as an embedded storage drive (e.g., a mobile embedded storage drive), an enterprise storage drive (ESD), a client storage device, or a cloud storage drive, or other suitable storage drives.

The data storage device 102 may be configured to be coupled to the host device 108, such as a wired communication path and/or a wireless communication path. For example, the data storage device 102 may include a host interface 120 that enables communication between the data storage device 102 and the host device 108, such as when the host interface 120 is communicatively coupled to the host device 108. In some examples, the communication between the data storage device 102 and the host device 108 includes transmitting data between the non-volatile 104 memory and the host device 108.

The host device 108 may include a processor and a memory. The memory may be configured to store data and/or instructions that may be executable by the electronic processor. The memory may be a single memory or may include one or more memories, such as one or more non-volatile memories, one or more volatile memories, or a combination thereof. The host device 108 may issue one or more commands to the data storage device 102, such as one or more requests to erase data at, read data from, or write data to a non-volatile memory 104 of the data storage device 102. For example, the host device 108 may be configured to provide data to be stored at the non-volatile memory 104 or to request data to be read from the non-volatile memory 104.

The host device 108 communicates via a memory interface that enables reading from the non-volatile memory 104 and writing to the non-volatile memory 104. In some examples, the host device 108 may operate in compliance with an industry specification, such as a Universal Flash Storage (UFS) Host Controller Interface specification. In other examples, the host device 108 may operate in compliance with one or more other specifications, such as a Secure Digital (SD) Host Controller specification or other suitable industry specification. The host device 108 may also communicate with the non-volatile memory 104 in accordance with any other suitable communication protocol.

The non-volatile memory 104 of the data storage device 102 may include a non-volatile memory (e.g., NAND, BiCS family of memories, or other suitable memory). In some examples, the non-volatile memory 104 may be any type of flash memory. The non-volatile memory 104 may include one or more memory devices. For example, the non-volatile memory 104 may be two-dimensional (2D) memory or three-dimensional (3D) flash memory.

The non-volatile memory 104 may include support circuitry, such as read/write circuitry to support operation of the non-volatile memory 104. In some examples, the read/write circuitry may be implemented in a single component. Alternatively, in some examples, the read/write circuitry may be divided into separate components of the non-volatile memory 104, such as read circuitry and write circuitry.

The controller 106 includes a host interface 120, a memory interface 122, a processor 124 (for example, a microprocessor, a microcontroller, a field-programmable gate array [“FPGA”] semiconductor, an application specific integrated circuit [“ASIC”], or another suitable programmable device), and a memory 126 (for example, a random access memory [“RAM”], a read-only memory [“ROM”], a non-transitory computer readable medium, or a combination thereof). In some examples, the memory 126 may be configured to store data and/or commands that may be executable by the processor 124. The controller 106 is illustrated in FIG. 1 in a simplified form. One skilled in the art would recognize that a controller for a non-volatile memory may include additional modules or components other than those specifically illustrated in FIG. 1. Additionally, although the data storage device 102 is illustrated in FIG. 1 as including the controller 106, in other implementations, the controller 106 is instead located within the host device 108 or is otherwise separate from the data storage device 102. As a result, operations that would normally be performed by the controller 106 (for example, wear leveling, bad block management, data scrambling, garbage collection, address mapping, etc.) can be performed by the host device 108 or another device that connects to the data storage device 102.

The controller 106 is configured to receive data and commands from the host device 108 and to send data to the host device 108. For example, the controller 106 may send data to the host device 108 via the host interface 120, and the controller 106 may receive data from the host device 108 via the host interface 120. The controller 106 is configured to send data and commands (e.g., a memory operation, which may be a command provided to the non-volatile memory 104) to the non-volatile memory 104 and to receive data from the non-volatile memory 104. For example, the controller 106 is configured to send data and a write command to cause the non-volatile memory 104 to store data to a specified address of the non-volatile memory 104. The write command may specify a physical address of a portion of the non-volatile memory 104 (e.g., a physical address of a word line of the non-volatile memory 104) that is to store the data.

The controller 106 is configured to send a read command to the non-volatile memory 104 to access data from a specified address of the non-volatile memory 104. The read command may specify the physical address of a region of the non-volatile memory 104 (e.g., a physical address of a word line of the non-volatile memory 104). The controller 106 may also be configured to send data and commands to the non-volatile memory 104 associated with background scanning operations, garbage collection operations, and/or wear-leveling operations, or other suitable memory operations.

The controller 106 may send a memory operation (e.g., a read command) to the non-volatile memory 104 to cause read/write circuitry to sense data stored in a storage element. For example, the controller 106 may send the read command to the non-volatile memory 104 in response to receiving a request for read access from the host device 108. In response to receiving the read command, the non-volatile memory 104 may sense the storage element (e.g., using the read/write circuitry) to generate one or more sets of bits representing the stored data.

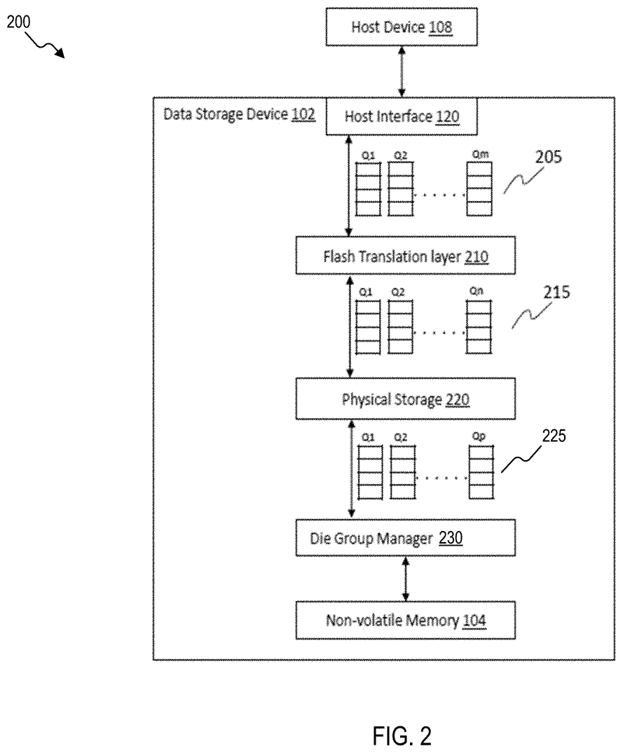

Turning now to FIG. 2, is block diagram illustrating one example of a data flow 200 of the system 100 for handling urgent commands for a data storage device 102 is shown, according to some embodiments. The data flow 200 begins at the host device 108, one or more urgent commands, is transmitted from the host device 108 to the host interface 120 of the controller 106 via, for example, the communication path 110. In some examples, the host interface 120 may determine an identifier of an urgent command in the one or more commands. For example, the host device 108 may be configured to generate an identifier which indicates that a command which has been transmitted is an urgent command. In another example, commands with the highest priority in a submission queue of the data storage device 102 may be received by the host interface 120 and assigned an identifier indicating an urgent request.

The host interface 120 transmits the urgent command to a first input queue 205 of an FTL 210 of the data storage device 102. For example, hardware accelerators (“HA”) or a hardware accelerator for write accumulation (“HAWA”) may be used by the host interface 120 to transmit the urgent command to the first input queue 205 of the FTL 210. The FTL 210 is a module stored, for example, in the memory 126 of the controller 106. The first input queue 205 transmits the command to the FTL 210 to be processed, for example to maintain logical-physical address mapping and/or other data management. In some examples, the FTL 210 may contain logic to process commands based on a priority and a weighted round robin mechanism. For example, requests such as PS exceptions, PS completion responses, FTL internally scheduled contexts, admin and infra requests receive higher priority than host read and host writes which are typically segregated by its stream, such as random and sequential. In some examples, the FTL 210 maintains a separate dedicated single level cell (“SLC”) open block to for processing urgent write request commands.

In some examples, XOR accumulation of urgent writes may need extra handling as previous writes and corresponding ordered XOR mode switches and swaps are bypassed. To avoid such dependencies and handling complexities, typical XOR accumulation may be disabled for urgent writes based on the requirement of data integrity. Thus, avoiding overhead time consumed by XOR mode switches, swaps and accumulation. Alternatively, in some examples, XOR accumulation may be postponed to idle time or during garbage collection time.

After processing, the FTL 210 transmits the urgent command to a second input queue 215 of the PS 220 of the data storage device 102. The PS 220 is a module stored, for example, in the memory 126 of the controller 106. The second input queue 215 transmits the command to the PS 220 to be processed, for example to process commands mapped to individual NAND dies of the data storage device 102. In some examples, the PS 220 may contain logic to process commands based on a type of command. For example, the PS 220 may process commands in order of priority based on request types such as host read, host write, control read/write, and relocation read.

After processing, the PS 220 transmits the urgent command to a third input queue 225 of a die group manager (“DGM”) 230 of the storage device 102. In some examples, urgent commands are immediately inserted into the DGM″ 230 list/shelf at the head by the PS 220 so that the urgent command is the next request to be processed. In some examples, when selecting the next request to service, the DGM 230 prioritizes requests by servicing the oldest infra request present, servicing the oldest exception request present, and if no infra or exception requests are present, servicing the oldest and highest priority request. In some examples, if the oldest request has been skipped more than a threshold number of times, the oldest entry is entry is selected even if it is not the highest priority.

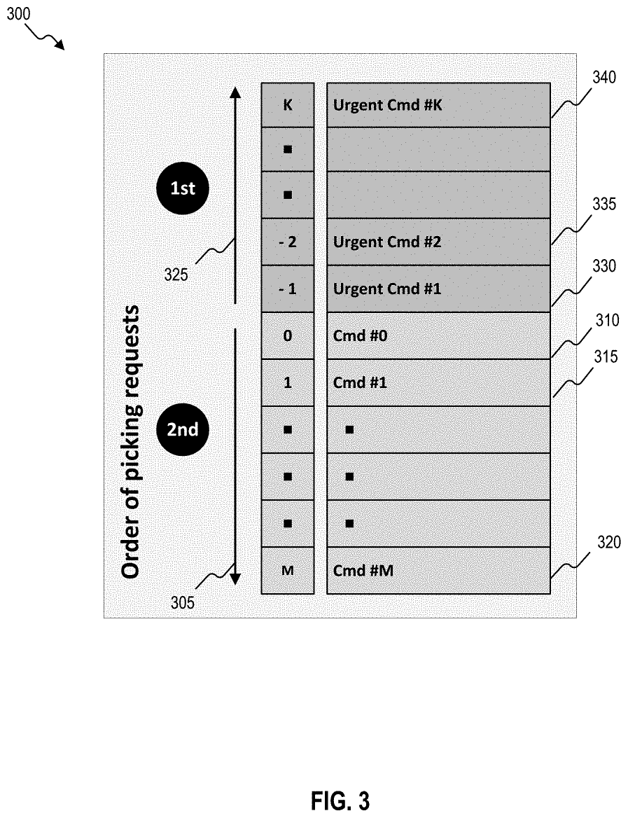

Turning now to FIG. 3, an illustrative example of a command management queue 300 of the data storage device 102 of FIG. 1 is shown, according to some embodiments. The command management queue 300 represents an input queue of one or more modules of the data storage device 102 that are configured to execute or otherwise process commands issued by the host device 108. For example, the command management queue 300 may include the first input queue 205 of the FTL 210, the second input queue 215 of the PS 220, and/or the third input queue 225 of the DGM 230. The command management queue 300 includes a plurality of indices which contain data items or commands which are written to and stored by one or more memory devices (e.g., the memory 126, etc.) of the data storage device 102 and are retrievable by the controller 106 in a definite order. In some examples, the command management queue 300 may be implemented entirely in hardware of the data storage device 102. In some examples, the command management queue 300 may be implemented in a firmware or software stored to the memory 126 of the controller 106.

The command management queue 300 includes a positive index queue 305 and a negative index queue 325. The positive index queue 305 may include a plurality of commands stored for retrieval by the controller 106. In some examples, the positive index queue 305 may receive any number of commands provided by the capabilities of the corresponding module in the data storage device 102, however, for illustrative purposes, in FIG. 3 the positive index queue 305 includes a normal command zero 310, a normal command one 315, and a normal command M 320. The positive index queue 305 may receive a command from the host device 108 and transmit the command to the positive index queue 305. In some examples, the method in which the commands stored to the positive index queue are manipulated, executed, or otherwise processed by the controller 106 may follow a first-in-first-out (“FIFO”) manner, wherein the first command received by the positive index queue 305 is the first command that is transmitted to the controller 106. For example, the positive index queue 305 may receive, in order, from the host device 108, normal command zero 310, normal command one 315, and normal command M 320. The positive index queue 305 may transmit each command to the controller 106 in the same order in which they were received (normal command zero 310, normal command one 315, and normal command M 320).

In some examples, commands stored to the positive index queue 305 correspond to one or more normal commands for operating the data storage device 102. For example, the one or more normal commands may be non-urgent commands configured for general operation of the data storage device 102 and/or to send and receive data to and from the host device 108 via the host interface 120.

The negative index queue 325 may include a plurality of commands stored for retrieval by the controller 106. In some examples, the negative index queue 325 may receive any number of commands provided by the capabilities of the corresponding module in the data storage device 102, however, for illustrative purposes, in FIG. 3 the negative index queue 325 includes an urgent command one 330, an urgent command two 335, and an urgent command K 340. In some examples, the method in which the commands stored to the negative index queue 325 are manipulated, executed, or otherwise processed by the controller 106 are similar to those described with respect to the positive index queue 305.

In some examples, commands stored to the negative index queue 325 correspond to one or more urgent commands for operating the data storage device 102. For example, the one or more urgent commands may include commands transmitted via the host device 108 which are tagged urgent, configured to read data from the non-volatile memory 104 or write data to the non-volatile memory 104, and be executed by the controller 106 as soon as possible. For example, the one or more urgent commands may include a critical host write or a critical host read.

In some examples, the positive index queue 305 and the negative index queue 325 of the command management queue 300 receive commands from host device 108 via the host interface 120. Alternatively, or in addition, the positive index queue 305 and the negative index queue 325 may receive commands via one or more memory devices associated with the data storage device 102 (e.g., the non-volatile memory 104, the memory 126, etc.).

In some examples, the positive index queue 305 and the negative index queue 325 of the command management queue 300 receive commands independently from one another. However, commands received by the negative index queue 325 may be assigned a higher priority to be executed by the controller 106 than those received by the positive index queue 305. For example, the positive index queue 305 may receive normal command zero 310 and normal command one 315 from the host device 108. At a later time, before normal command zero 310 and normal command one 315 have been transmitted from the command management queue 300, the negative index queue 325 may receive urgent command one 330 and urgent command two 335 from the host device 108. Although the positive index queue 305 received normal command zero 310 and normal command one 315 before the negative index queue 325 received the urgent command one 330 and the urgent command two 335, the commands of the negative index queue 325 are assigned higher priority than those of the positive index queue 305, thus, the command management queue 300 may transmit, in order to the controller 106, urgent command one 330, urgent command two 335, normal command zero 310, and normal command one 315.

Although the command management queue 300 is described in this example as receiving four separate commands before a single one is transmitted to the controller 106, it is to be understood that the manner in which the command management queue 300 receives and transmits commands may be dynamic and include an infinite number of commands. For example, the command management queue 300 may receive the normal command zero 310 at the positive index queue 305, and transmit the normal command zero 310 to the controller 106 to be processed. The command management queue 300 may receive the normal command one 315 at the positive index queue 305, then receive urgent command one 330 at the negative index queue 325. The command management queue 300 urgent command one 330 is assigned a higher priority than normal command one 315, thus urgent command one 330 is transmitted first to the controller 106, then the normal command one 315 is transmitted to the controller 106. Thus, the inclusion of the negative index queue 325 provides an advantageous feature in that urgent commands issued by the host device 108 are able to be immediately executed by the controller 106 by temporarily freezing commands previously issued by the host device 108 without aborting them.

In some examples, the negative index queue 325 maintains a predetermined number of negative indices for each backend queue responsible for executing sub-commands associated with urgent commands. For example, the data storage device 102 may include the FTL 210 and the PS 220. The negative index queue 325 may maintain one negative index of a plurality of negative indices for each of the FTL 210 and the FTL 210 to execute sub-commands associated with urgent commands.

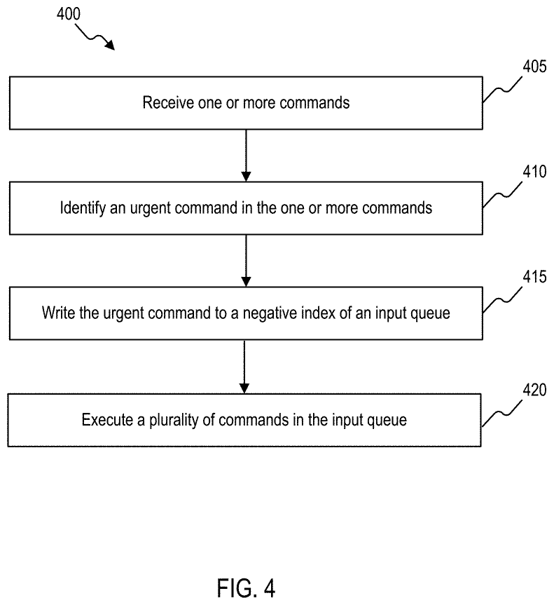

Turning now to FIG. 4, a flow chart illustrating an example method 400 for handling urgent commands for the data storage device 102 is shown, according to some embodiments.

At block 405, the data storage device 102 receives one or more commands. In some examples, the one or more commands may be received the data storage device 102 from the host device 108 via the host interface 120. The one or more commands may include one or more normal commands configured to operate the data storage device 102 and/or one or more urgent commands, for example critical host read or critical host write, configured to operate the data storage device 102.

At block 410 the controller 106 identifies an urgent command in the one or more commands. In some examples, the host device 108 is configured to generate one or more urgent commands. The one or more urgent commands may be configured to contain an identifier indicating an urgent command, such as one identifiable by the processor 124 of the controller 106 via referencing a look-up table stored to the memory 126.

At block 415, the controller 106 writes the urgent command to a negative index queue of an input queue of the data storage device 102. For example, the controller 106 may write the urgent command to the negative index queue 325 of the command management queue 300. In some examples, the urgent command is written to a location in the memory 126 associated with the command management queue 300. In some examples, an executor of the urgent command may look for commands in the negative index queue 325. For example, the controller 106 may determine if there an urgent command stored in the negative index queue 325 of the command management queue 300 via an identifier as discussed with respect to block 415.

In response to determining an urgent command in the negative index queue 325, the urgent command may be transmitted from the command management queue 300 via the controller 106 to a low-level executor module, such as the DGM 230. In some examples, the urgent command is transmitted to the low-level executor module without aborting any commands currently stored in the positive index queue 305.

In response to determining there is not an urgent command in the negative index queue 325, the command management queue 300 may continue to process any commands stored in the positive index queue 305. For example, the controller 106 may determine there is not an urgent command in the negative index queue 325 by determining that none of the commands stored in the command management queue 300 include an identifier indicative of an urgent command.

At block 420, the controller 106 executes a plurality of commands in the input queue. In some examples, after the urgent command is processed by the command management queue 300, the urgent command is transmitted to the processor 124 of the controller 106 to be executed. For example, after the urgent command is received by the command management queue 300, the urgent command may be transmitted to a low-level executor module of the data storage device 102, such as the DGM 230, and executed without aborting any commands currently stored in the positive index queue 305. After the urgent commands stored in the negative index queue 325 are executed, the processor 124 may continue to execute any commands stored in the positive index queue 305.

In some examples, the command management queue 300 may store a plurality of commands. For example, a first normal command and a second normal command may have written to the positive index queue 305. The urgent command may be identified and written to the negative index queue 325 after the first normal command and the second normal command have already been written to the positive index queue 305. As commands written to the negative index queue 325 are assigned a higher priority than those of the positive index queue, the urgent command may be transmitted to processor 124 of the controller 106 to be executed before the first normal command or the second normal command are executed by the processor 124.

In some examples, the data storage device 102 includes only one command management queue and each one of the plurality of negative indices of the negative index 325 may correspond to a particular module of the data storage device 102. For example, the urgent command one 330 may correspond to urgent commands received by the FTL 210 and the urgent command two 335 may correspond to urgent commands received by the PS 220.

In some examples, the urgent command may be transmitted from a first command management queue 300 to one of a plurality command management queues 300. For example, the urgent command may be received by the command management queue 300 corresponding to the FTL 210. After the urgent command is processed in accordance with the command processing methods described with respect to FIG. 3, the urgent command may be transmitted to the command management queue 300 corresponding to the PS 220 for similar processing.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A data storage device comprising:
a non-volatile memory; and
a controller coupled to the non-volatile memory, the controller configured to:
receive, from an external electronic device, one or more commands to read or write data to the non-volatile memory,
identify an urgent command in the one or more commands,
write the urgent command to a negative index of an input queue of the data storage device, and
execute a plurality of commands in the input queue.

2. The data storage device of claim 1, wherein the input queue includes a plurality of input queues of the data storage device.

3. The data storage device of claim 2, wherein the plurality of input queues include a first input queue of a flash translation layer of the data storage device and a second input queue of a physical storage of the data storage device.

4. The data storage device of claim 3, wherein the negative index includes one or more negative indices, each of the one or more negative indices of the plurality of negative indices corresponding to one of the plurality of input queues of the data storage device.

5. The data storage device of claim 4, wherein the controller is further configured to:
write the urgent command to a first negative index of the plurality of negative indices, and
write the urgent command to a second negative index of the plurality of negative indices.

6. The data storage device of claim 1, wherein the controller is further configured to identify the urgent command in the one or more commands based on an identifier of the urgent command transmitted by the external electronic device.

7. The data storage device of claim 1, wherein the controller is further configured to:
identify a normal command of the one or more commands, and
write the normal command to a positive index of the input queue.

8. The data storage device of claim 7, wherein, to execute the plurality of commands, the controller is further configured execute the urgent command that has been written to the negative index before any command written to the positive index.

9. The data storage device of claim 1, wherein the urgent command is a critical host read operation or a critical host write operation.

10. A method performed by a data storage device including a controller coupled to a non-volatile memory, the method comprising:
receiving, at the controller, one or more commands from an external electronic device to read or write data to the non-volatile memory;
identifying, with the controller, an urgent command in the one or more commands;
writing, with the controller, the urgent command to a negative index of an input queue of the data storage device; and
executing, with the controller, a plurality of commands in the input queue.

11. The method of claim 10, wherein the input queue includes a plurality of input queues of the data storage device.

12. The method of claim 11, wherein the plurality of input queues include a first input queue of a flash translation layer of the data storage device and a second input queue of a physical storage of the data storage device.

13. The method of claim 12, wherein the negative index includes a plurality of negative indices, each of the one or more negative indices of the plurality of negative indices corresponding to one of the plurality of input queues of the data storage device.

14. The method of claim 13, further comprising:
writing, with the controller, the urgent command to the first input queue,
writing, with the controller, the urgent command to a first negative index of the plurality of negative indices,
writing, with the controller, the urgent command to the second input queue, and
writing, with the controller, the urgent command to a second negative index of the plurality of negative indices.

15. The method of claim 10, further comprising identifying the urgent command in the one or more commands based on an identifier of the urgent command transmitted by the external electronic device.

16. An apparatus, comprising:
means for receiving one or more commands from an external electronic device to read or write data to the non-volatile memory;
means for identifying an urgent command in the one or more commands;
means for writing the urgent command to a negative index of an input queue of a data storage device; and
means for executing a plurality of commands in the input queue.

17. The apparatus of claim 16, wherein the input queue includes a plurality of input queues of the data storage device.

18. The apparatus of claim 17, wherein the plurality of index queues include a first input queue of a flash translation layer of the data storage device and a second input queue of a physical storage of the data storage device.

19. The apparatus of claim 18, wherein the negative index includes one or more negative indices, each of the one or more negative indices of the plurality of negative indices corresponding to one of the plurality of input queues of the data storage device.

20. The apparatus of claim 19, further comprising:
means for writing the urgent command to the first input queue,
means for writing the urgent command to a first negative index of the plurality of negative indices,
means for writing the urgent command to the second input queue, and
means for writing the urgent command to a second negative index of the plurality of negative indices.
